(19) United States
(12) Patent Application Publication
(10) Pub. No.: US 2023/0079815 A1
(43) Pub. Date: Mar. 16, 2023

(54) CALCULATE FAIRNESS OF MACHINE LEARNING MODEL BY IDENTIFYING AND FILTERING OUTLIER TRANSACTIONS

(71) Applicant: International Business Machines Corporation, Armonk, NY (US)

(72) Inventors: Ravi Chandra Chamarthy, Hyderabad (IN); Manish Anand Bhide, Hyderabad (IN); Arunkumar Kalpathi Suryanarayanan, CHENNAI (IN); Madhavi Katari, Hyderabad (IN)

(21) Appl. No.: 17/476,582

(22) Filed: Sep. 16, 2021

(51) Int. Cl. G06N 7/00; G06K 9/62

(52) U.S. Cl. CPC G06N 7/005; G06K 9/623; G06K 9/6298

(57) ABSTRACT

An approach is disclosed that inputs data points to a trained artificial intelligence (AI) model with an outlier model that identifies data points on which the AI model has been trained. A value is received from the outlier model corresponding to each of the data points with the received value being a prediction of whether the AI model has been trained on the respective data point. A bias analysis is performed on the trained AI model using a subset of the data points that received a prediction that indicates that the trained AI model was trained with the respective data point.

### BACKGROUND

Human biases can influence algorithms and result in discriminatory outcomes. However, it is difficult to discern how pervasive these biases are in the technology we develop and use in our everyday life. Mitigation of bias in AI models is a challenging endeavor for AI and automated decision-making systems. Reduction of biases results in a reduction of the likelihood of negative outcomes. Society continues to evolve with rapid innovation in emerging technologies, in particular AI. Industry, academia, governments, and consumers share a responsibility to ensure that AI systems are tested and assessed for bias. In addition, any action or practice prohibited by anti-discrimination laws and regulations should continue to be prohibited when it involves an automated decision-making system, such as an AI system. To support bias mitigation strategies, organizations often create, implement, and operationalize AI ethics principles, and ensure appropriate governance is in place to provide ongoing review and oversight of AI systems.

### SUMMARY

An approach is disclosed that inputs data points to a trained artificial intelligence (AI) model with an outlier model that identifies data points on which the AI model has been trained. A value is received from the outlier model corresponding to each of the data points with the received value being a prediction of whether the AI model has been trained on the respective data point. A bias analysis is performed on the trained AI model using a subset of the data points that received a prediction that indicates that the trained AI model was trained with the respective data point.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a high-level diagram depicting steps taken during data point outlier identification;

FIG. 4 is a depiction of a flowchart showing the logic used to train a binary or multi-classification outlier identification model;

FIG. 5 is a depiction of a flowchart showing the logic used to train a regression outlier identification model; and

FIG. 6 is a depiction of a flowchart showing the logic used to check a data point against the appropriate trained outlier detection model.

### DETAILED DESCRIPTION

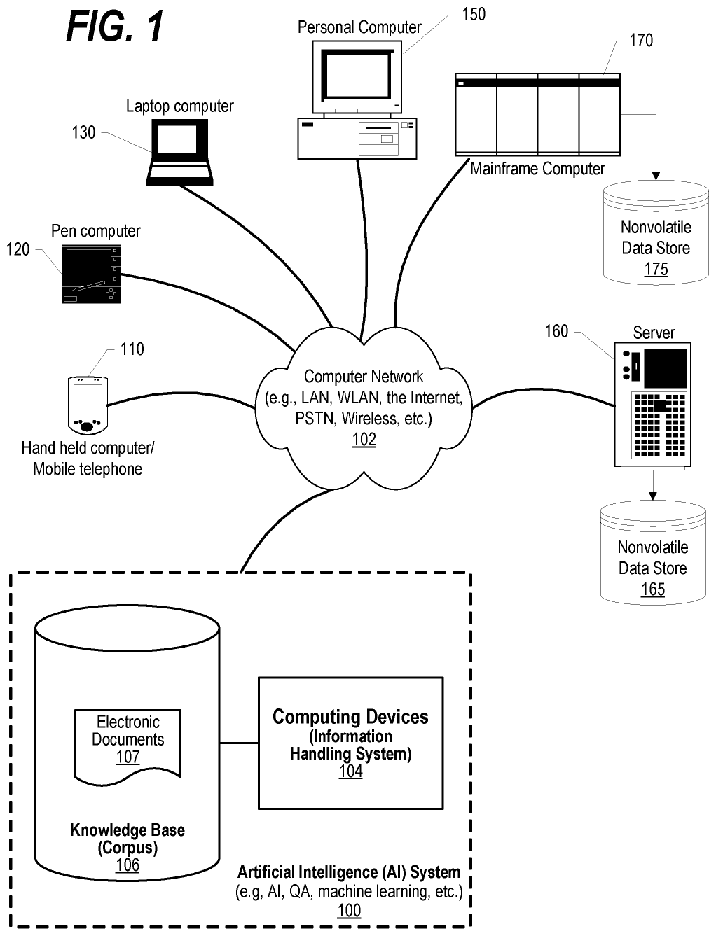

FIGS. 1-6 describe an approach to perform a process to calculate the fairness of a machine learning model by identifying and filtering out outlier transactions. While there are multiple traditional techniques to detect bias in machine learning models for both regression and classification type models, traditional systems lack the ability to identify and filter the outlier data points before measuring the fairness of the machine learning model.

For example, consider a scenario where there are 100 transactions with data points belonging to 50 male and 50 female applications for loans. Traditionally, to determine whether the AI model is exhibiting bias against females, we consider all the female applicants and calculate the bias against their counterpart male applicants. However, there could be cases where the data would contain outliers such as a female with an age of 20 but with a profession as “Retired,” or a female with an age of 60 and a profession as “School Student.” Most probably, the prediction for these transactions would not be correct prediction as these represent outlier transactions. For example, if the result “Loan Approved” is a favorable outcome, then for the example female with age of 20 and profession of “Retired,” the model would have predicted an unfavorable outcome as “Loan Rejected,” because the model is not trained on such kinds of extreme (outlier) data points. In addition, if the system considers these data point while computing the “fairness” of the machine learning model, then the fairness outcome might be wrong due to the presence of such outlier data. Furthermore, such incorrect outcomes might lead to bad press as well as incorrect judgement to the analysts working with the machine learning model.

The disclosed approach identifies outlier transactions and filter them out before calculating the fairness of the machine learning model. The approach identifies and filters out such outlier transactions before calculating the bias for the machine learning model.

The following terminology is used herein: “unfavorable outcome,” such as receiving a rejection or a worse rate when applying for a loan; “favorable outcome,” such as receiving an approval or a better rate when applying for a loan; “monitored group” is the group that is most commonly receiving unfavorable outcomes due to inherent bias, for which the approach is used to more accurately measure fairness or bias. In the previous loan example, this group would be “females.” “Reference group” is the group that is more commonly receiving favorable outcomes as compared to the monitored group. In the above loan example, this group would be “males.” “Fairness threshold” is a threshold of the percentage of the monitored group that ought to receive a favorable outcome as compared to the reference group. The fairness threshold is dependent of the type of AI model (e.g., loan model, insurance coverage model, hiring model, etc.).

There are numerous outlier detection algorithms already available say using Isolation Forest, Minimum Covariance Determinant, Local Outlier Factor, etc. However, using these algorithms, say in a population of 100 data points, if we detect 10 are outlier data points and should not be considered for bias checking, then we might end up making a mistake by assuming that the model has wrongly predicted for these data points. On the contrary, in reality, if the model has been trained on these specific data points, then the model prediction could as well be correct for these data points so such data points should not be discarded before further analysis. Instead, the approach described herein provides an algorithm that detect outlier transactions and filters out those outlier transactions when a model has not been trained to handle such outlier transactions.

Essentially the approach identifies, given a data point, whether or not the model has already been exposed to such a data point during the model's training process. If the model has already been exposed (and trained) for such a data point, then the approach does not ignore the model outcome and indeed considers the data point for bias checking. For example, if the model is trained with a data point [Female, 20, Retired, XX, XY, Loan Rejected] and when scored with a data point say, [Female, 22, Retired,)(X, XZ] and the model predicted the outcome as Loan Rejected, then we should consider such datapoint, because the model is trained with it (with age of 20 and 22 being deemed equivalent in terms of model evaluation). On the other hand, if the model is not trained with such a data point, and when scored if we get the outcome as Loan Rejected, then we should not consider this data point for bias checking and this data point should be filtered out before checking the model for bias. Below are embodiments of algorithms to use in identifying outliers for (1) Binary and Multi-classification models, and (2) Regression models.

For binary and multi-classification models, the model prediction is associated with a confidence value, otherwise called as probability of the prediction. The approach uses an internal machine learning model that, when scored with a data point, predicts whether the model has already been trained with such data point. In one embodiment, the approach uses a label value called “has_been_trained” which is set to 0 (FALSE, model not trained for data point), or 1 (TRUE, model trained for data point). The training of this internal model is generated as described in the next steps.

For the given set of data points on which we need to calculate fairness checking, the approach performs the following. First, if the confidence of the prediction is higher than a configurable threshold value (e.g., 50%, etc.) then the approach determines that the data point is something that the model has been trained on, and give a label value to “has_been_trained” of 1 indicating that the model has been trained for the data point. However, if the confidence of the prediction is less than the threshold value, then the approach perturbs the record on the configured fairness attribute or set of fairness attributes and score it against the original model. This is done to determine if the model has been trained on a data point that is substantially similar to the given data point (e.g., the example of the female applicant that is 20 years old and “retired” with the model being trained for a female application that is 22 years old and “retired,” etc.).

If the prediction of this perturbed record changed and if the confidence of that prediction is higher than the threshold, then the approach assigns the label value of 1 to the original data point indicating that the model has been trained for the data point and also assigns the label value of 1 to the perturbed data record as well. In this manner, the model is found to have been trained on such data points (original data point and the perturbed data point).

If the prediction changed and if the confidence of that prediction is less than the threshold, then it means there exists another data point which model has not been trained on, and for the original record and the perturbed record are assigned the label value of 0 indicating that the model has not been trained for the data points. Finally, if the prediction did not change, and the confidence value is low, then the approach assigns the original record and the perturbed record a label value of 0 indicating that the model has not been trained for the data points.

During runtime, the approach runs each data point against this internal model, trained as described above. If the internal model predicts a 1 indicating that the model has been trained for the data point, then the approach considers this data point for bias checking. On the other hand, if the internal model predicts a 0 indicating that the model has not been trained for the data point, then the approach filters out this data point and does not consider it for bias checking. Over time and after multiple runs, the approach improves the internal model with more training data and the exposure of the model to more data points.

In case of regression-based models, the machine learning model predicts an outcome such as a loan amount to be granted, a possible monthly electricity bill amount, a possible monthly saving amount and the like, but does not provide a confidence value. Such example prediction values would appear like [3, 4, 5, 6, 20, 2000, 7, 9, 10, 11, 12, 19] with the numbers being the predicted outcomes.

From a human intuition point of view, the outlier from the example in the regression-based model would likely be the prediction value of ‘2000’ as it is quite different from the other listed outcomes. As described below, the approach determines whether such a record is actually an outlier and, therefore, whether it should be considered for bias when checking the model.

Here, the approach uses an internal machine learning model that, when scored with a data point, predicts whether the model has been trained with such a data point. If the approach determines that the data point is something on which the model has been trained, a label value to “has_been_trained” is set to ‘1’ indicating that the model has been trained for the data point. On the other hand, if the approach determines that the data point is something on which the model has not been trained, a label value to “has_been_trained” is set to ‘0’ indicating that the model has not been trained for the data point.

The training of the internal model for the regression-based model is generated as described in the following steps. Considering all the prediction values, the approach calculates a z-score for each data point. Here, the z-score=(predicted value—Mean of all predicted values)/Standard Deviation of all predicted values. In one embodiment, the standard threshold value for z-score is between −3 and 3, and any value outside this threshold is an outlier. Using the example from above, going by the standard z-score usage, the approach analyzes the data point with the prediction value 2000 (with the z-score=3.3) as being an outlier. However, as with the binary and multi-classification models, the approach further identifies whether the model is actually trained on such a data point.

The approach perturbs each data record, scores it with the model, and calculates the perturbed record's z-score. If the original record z-score and the perturbed record z-score are outside the threshold range, the approach classifies both of these records as outliers and give the label value of “has_been_trained” to ‘0’ indicating that the model has not been trained for the data point. On the other hand, the approach assigns a label value to “has_been_trained” to ‘1’ indicating that the model has been trained for the data point.

During runtime, the approach processes each data point against this internal model that was trained as described above. If the internal model predicts a ‘1’ for a data point, then the approach includes the data point for bias checking. Otherwise, if the internal model predicts a ‘0’ for a data point, then the approach does not include the data point for bias checking. Over a period of time and over multiple runs, the approach improves the internal model with more training data with the model being exposed to more data points.

FIG. 1 depicts a schematic diagram of one illustrative embodiment of artificial intelligence (AI) system 100 in a computer network 102. AI system 100 includes artificial intelligence computing device 104 (comprising one or more processors and one or more memories, and potentially any other computing device elements generally known in the art including buses, storage devices, communication interfaces, and the like) that connects AI system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. AI system 100 and network 102 may enable functionality, such as question/answer (QA) generation functionality, for one or more content users. Other embodiments of AI system 100 may be used with components, systems, sub-systems, and/or devices other than those that are depicted herein.

AI system 100 maintains knowledge base 106, also known as a “corpus,” which is a store of information or data that the AI system draws on to solve problems. This knowledge base includes underlying sets of facts, assumptions, models, and rules which the AI system has available in order to solve problems.

AI system 100 may be configured to receive inputs from various sources. For example, AI system 100 may receive input from the network 102, a corpus of electronic documents 107 or other data, a content creator, content users, and other possible sources of input. In one embodiment, some or all of the inputs to AI system 100 may be routed through the network 102. The various computing devices on the network 102 may include access points for content creators and content users. Some of the computing devices may include devices for a database storing the corpus of data. The network 102 may include local network connections and remote connections in various embodiments, such that artificial intelligence 100 may operate in environments of any size, including local and global, e.g., the Internet. Additionally, artificial intelligence 100 serves as a front-end system that can make available a variety of knowledge extracted from or represented in documents, network-accessible sources and/or structured data sources. In this manner, some processes populate the artificial intelligence with the artificial intelligence also including input interfaces to receive knowledge requests and respond accordingly.

In one embodiment, the content creator creates content in electronic documents 107 for use as part of a corpus of data with AI system 100. Electronic documents 107 may include any file, text, article, or source of data for use in AI system 100. Content users may access AI system 100 via a network connection or an Internet connection to the network 102, and, in one embodiment, may input questions to AI system 100 that may be answered by the content in the corpus of data. As further described below, when a process evaluates a given section of a document for semantic content, the process can use a variety of conventions to query it from the artificial intelligence.

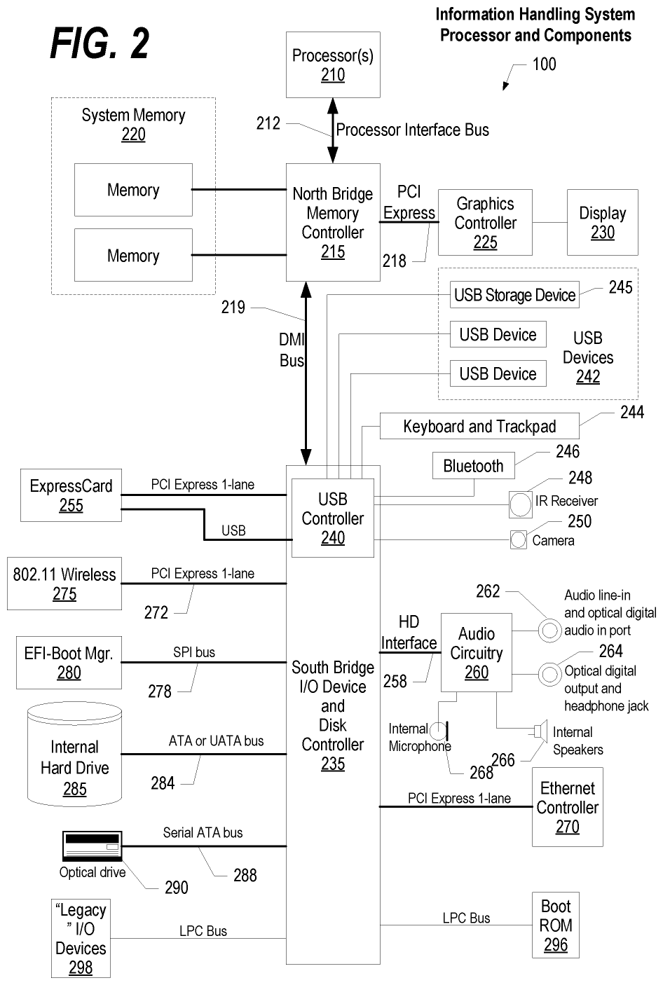

Types of information handling systems that can utilize AI system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 0.802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

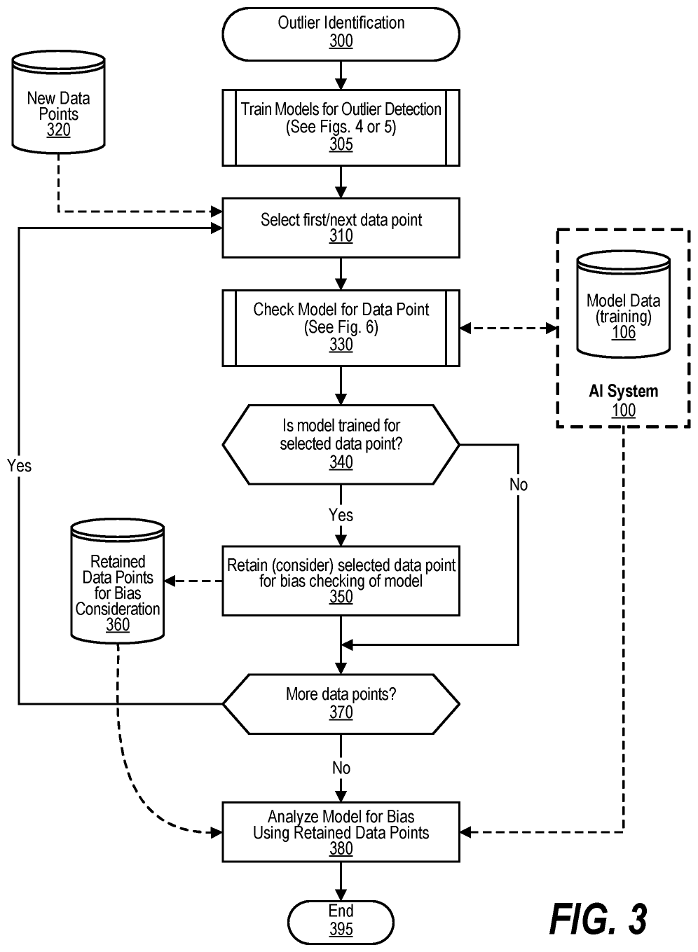

FIG. 3 is a high-level diagram depicting steps taken during data point outlier identification. FIG. 3 processing commences at 300 and shows the steps taken by a process that performs outlier Identification for bias analysis in artificial intelligence (AI) models.

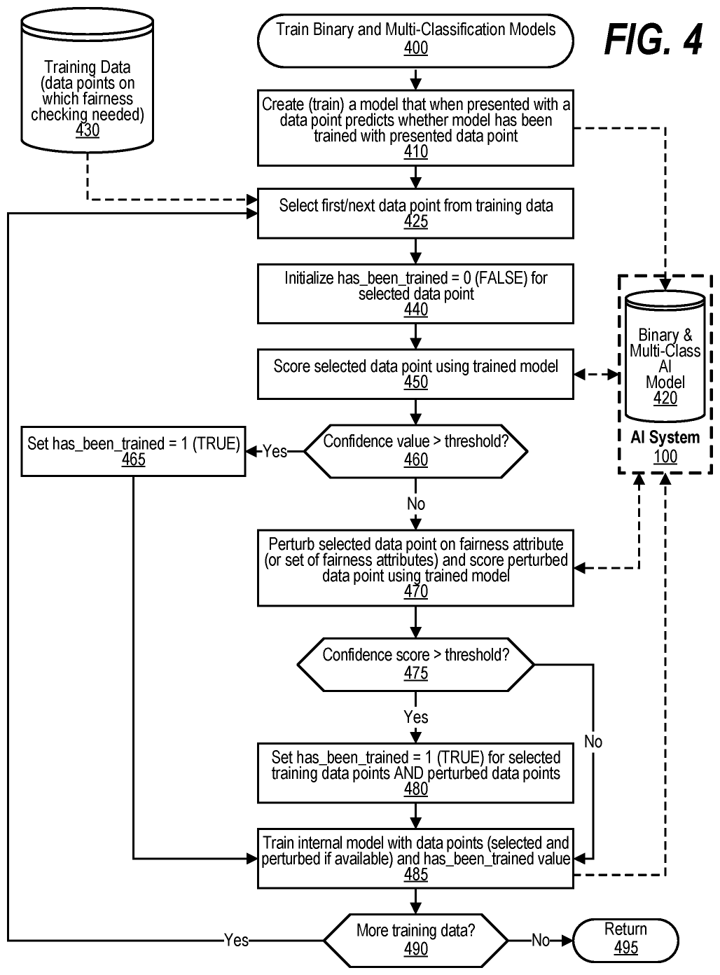

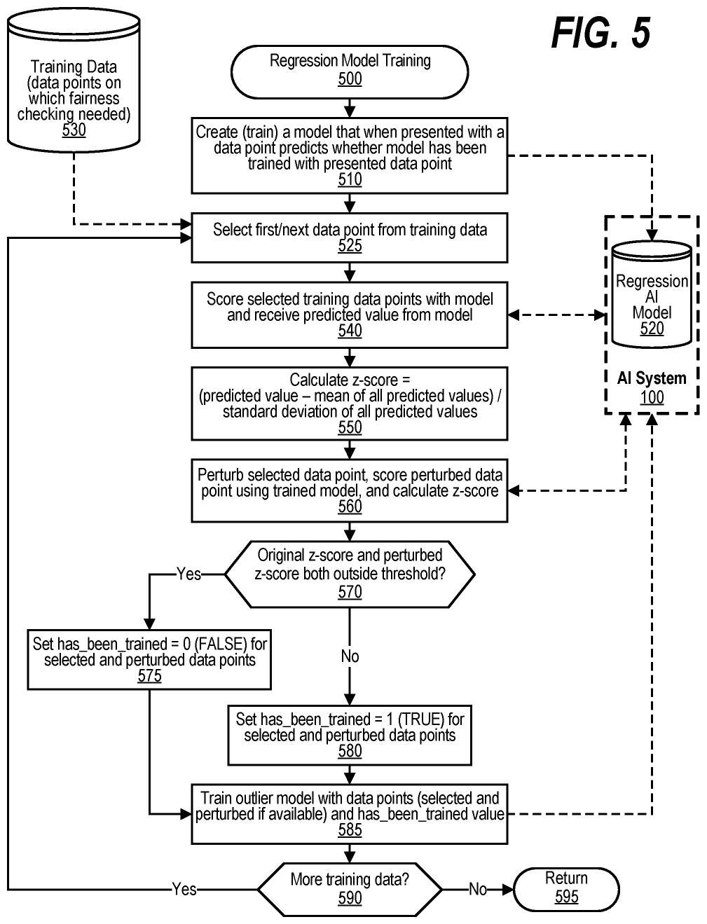

At predefined process 305, the process performs the appropriate Training routine (see FIG. 4 for binary/multi-classification AI model training and FIG. 5 for regression type AI model training along with corresponding text for processing details). At step 310, the process selects the first data point from data store 320.

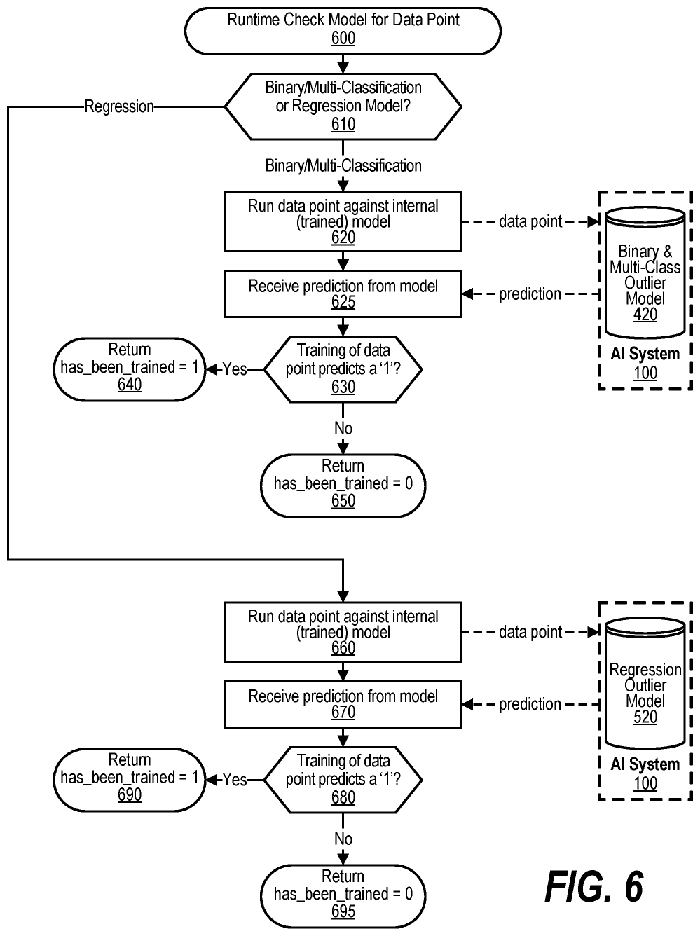

At predefined process 330, the process performs the Check Model for Data Point routine (see FIG. 6 and corresponding text for processing details). This routine inputs the selected data point to the AI model and receives a response that is used to predict whether the model has been trained using such a data point.

The process determines as to whether the response received from the AI predicts that the model has been trained for the selected data point (decision 340). If the model has been trained for the selected data point, then decision 340 branches to the ‘yes’ branch whereupon, at step 350, the process retains (for further consideration) the selected data point for bias checking analysis of the AI model. This retained data is stored in data store 360.

On the other hand, if the model has not been trained for the selected data point, then decision 340 branches to the ‘no’ branch bypassing step 350. The process determines as to whether there are more data points to process (decision 370). If there are more data points to process, then decision 370 branches to the ‘yes’ branch which loops back to step 310 to select and process the next data point as described above. This looping continues until all data points have been processed, at which point decision 370 branches to the ‘no’ branch exiting the loop with processing ending at 395.

FIG. 4 is a depiction of a flowchart showing the logic used to train a binary or multi-classification outlier identification model. FIG. 4 processing commences at 400 and shows the steps taken by a process that trains an AI model that classifies inputs into one of a plurality of classifications (e.g., Binary models, Multi-Classification Models, etc.).

At step 410, the process creates, or “trains,” AI outlier model 420 so that, when presented with a data point predicts whether model has been trained with presented data point. This model is stored in AI system 100. At step 425, the process selects the first data point from the set of training data that is retrieved from data store 430. At step 440, the process initializes a variable to indicate that the model has not been trained for the selected data point (variable has_been_trained=0 (FALSE) for selected data point).

At step 450, the process scores selected data point using trained model. Step 450 inputs the selected data point to trained AI system 100 and receives a value back from the AI system that has a confidence value as to whether the AI model has been trained using the selected data point. The process determines as to whether the confidence value is greater than a threshold indicating that the AI model has been trained using the selected data point (decision 460). If the AI model has been trained using the selected data point, then decision 460 branches to the ‘yes’ branch whereupon, at step 465, the process sets the variable to indicate that the AI model has been trained for the selected data point (sets has_been_trained=1 (TRUE)). On the other hand, if the AI model has not been trained using the selected data point, then decision 460 branches to the ‘no’ branch for further processing using steps 470 through 480.

Steps 470 through 480 are performed when the AI model indicated that the AI model was not trained for the selected data point with these steps perturbing the data to determine if the AI model was trained using a substantially similar data point. At step 470, the process perturbs the selected data point on a fairness attribute, or on a set of fairness attributes, and scores the perturbed data point using the trained model. Again, the scoring is performed by the perturbed data point being inputted to the AI model and a confidence value being returned from the AI model that indicates whether the AI model has been trained using the perturbed data point.

The process determines as to whether the received confidence value is greater than a threshold indicating that the AI model has been trained using the perturbed data point (decision 475). If the AI model has been trained using the perturbed data point, then decision 475 branches to the ‘yes’ branch whereupon, at step 480, the process sets the variable to indicate that the AI model has been trained for the selected data point (sets has_been_trained=1 (TRUE)) and also sets a variable to indicate that the AI model has been trained for the perturbed data point. On the other hand, if the AI model has not been trained using the perturbed data point, then decision 475 branches to the ‘no’ branch bypassing step 480.

At step 485, the process trains the internal model with one or more data points (the selected data point and, if perturbed, the perturbed data point). Now, after being trained, when the AI model is presented with the data point it can return a value (has_been_trained) indicating whether the model has been trained for such a data point. The process determines as to whether more training data is yet to be processed (decision 490). If there is more training data, then decision 490 branches to the ‘yes’ branch which loops back to step 425 to select and process the next data point as discussed above. This looping continues until all data points from the training set of data in data store 430 have been processed, at which point decision 490 branches to the ‘no’ branch exiting the loop. Processing then returns to the calling routine (see FIG. 3) at 495.

FIG. 5 is a depiction of a flowchart showing the logic used to train a regression outlier identification model (e.g., a regression type of AI model, etc.). FIG. 5 processing commences at 500 and shows the steps taken by a process that performs training for a regression type of AI model. At step 510, the process creates, or “trains,” AI outlier model 520 model so that, when presented with a data point, predicts whether model has been trained with presented data point. This model is stored in AI system 100.

At step 525, the process selects the first data point from a set of training data that is retrieved from data store 530. At step 540, the process scores the selected training data point with the trained AI regression type model and receives a predicted value from the model. Here, the data point is input to AI system 100 with AI system 100 returning a predicted value based on the inputted data point.

At step 550, the process calculates a score (a “z-score”). In one embodiment, the score is calculated by finding a difference between the predicted value and the mean of all predicted values and dividing this difference by the standard deviation of all predicted values (predicted value—mean of all predicted values)/standard deviation of all predicted values).

At step 560, the process perturbs the selected data point, scores the perturbed data point by inputting the perturbed data point to the AI system using the trained regression type model, receives a predicted value corresponding to the perturbed data point, and calculates a score (z-score) using the algorithm set forth in step 550.

The process determines whether the original z-score corresponding to the selected data point and the perturbed z-score corresponding to the perturbed data point are BOTH outside of a threshold (decision 570). If both scores are outside of the threshold, then decision 570 branches to the ‘yes’ branch whereupon, at step 575, the process sets a variable indicating that the model has not been trained for the selected data point (sets has_been_trained=0 (FALSE)) for both the selected and perturbed data points.

On the other hand, if at least one of the scores for either the data point or the perturbed data point are within the threshold, then decision 570 branches to the ‘no’ branch whereupon, at step 580, the process sets a variable indicating that the model has been trained for both the selected data point and the perturbed data point (sets has_been_trained=1 (TRUE) for both the selected and perturbed data points). At step 585, the process trains the internal outlier model in AI system 100 with the data points (selected and perturbed) using their corresponding has_been_trained value as discussed above.

The process determines as to whether more training data is yet to be processed (decision 590). If there is more training data, then decision 590 branches to the ‘yes’ branch which loops back to step 525 to select and process the next data point as discussed above. This looping continues until all data points from the training set of data in data store 530 have been processed, at which point decision 490 branches to the ‘no’ branch exiting the loop. Processing then returns to the calling routine (see FIG. 3) at 595.

FIG. 6 is a depiction of a flowchart showing the logic used to check a data point against the appropriate trained outlier detection model. FIG. 6 processing commences at 600 and shows the steps taken by a process that performs a runtime check on an AI model to determine if the model has been trained for a given data point. The process determines as to whether the model is a classification type of model (e.g., binary model, multi-classification, etc.) or a regression type of AI model (decision 610). If a classification type of model is being used, then decision 610 branches to the ‘binary/multi-classification’ branch to perform steps 620 through 650. On the other hand, if a regression type of model is being used, then decision 610 branches to the ‘regression’ branch to perform steps 660 through 695.

If a binary/multi-classification type of model is being used, then steps 620 through 650 are performed. At step 620, the process processes the data point against outlier model 420 (an internal pretrained model) in AI system 100. At step 625, the process receives a prediction from from AI system 100 regarding whether the AI model has been trained for the data point. In one embodiment, a ‘0’ indicates that the model has not been trained for the data point and a ‘1’ indicates that the model has been trained for the data point.

The process determines as to whether the AI system predicted that the model has been trained for the data point (decision 630). If the AI system predicted that the model has been trained for the data point, then decision 630 branches to the ‘yes’ branch and at 640 processing returns a value indicating that the model has been trained for the data point to the calling procedure. On the other hand, if the AI system did not predict that the model has been trained for the data point, then decision 630 branches to the ‘no’ branch whereupon at 650 processing returns a value indicating that the model has not been trained for the data point to the calling procedure.

If a regression model is being used, then steps 660 through 695 are performed. At step 660, the process processes the data point against outlier model 520 (an internal pretrained model) in AI system 100. At step 670, the process receives a prediction from AI system 100 regarding whether the AI model has been trained for the data point. In one embodiment, a ‘0’ indicates that the model has not been trained for the data point and a ‘1’ indicates that the model has been trained for the data point.

The process determines as to whether the AI system predicted that the model has been trained for the data point (decision 680). If the AI system predicted that the model has been trained for the data point, then decision 680 branches to the ‘yes’ branch and at 690 processing returns a value indicating that the model has been trained for the data point to the calling procedure. On the other hand, if the AI system did not predict that the model has been trained for the data point, then decision 680 branches to the ‘no’ branch whereupon at 695 processing returns a value indicating that the model has not been trained for the data point to the calling procedure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method, implemented by an information handling system that includes a processor and a memory, the method comprising:
inputting a plurality of data points to a trained artificial intelligence (AI) model with an outlier model that identifies data points on which the AI model has been trained;
receiving, from the outlier model, a value corresponding to each of the plurality of data points, wherein the received value indicates a prediction of whether the AI model has been trained with the respective data point; and
performing a bias analysis of the trained AI model using a subset of the plurality of data points that received a value indicating that the trained AI model has been trained with the respective data point.

2. The method of claim 1 further comprising:
training the outlier model to predict whether the trained AI model has been trained with a given data point.

3. The method of claim 2 wherein the trained AI model has been trained to recognize a plurality of classifications and wherein the method further comprises:
inputting the plurality of data points to the trained AI model;
receiving, from the trained AI, a first confidence value corresponding to each of the plurality of data points; and
retaining each of the plurality of data points in the subset of the plurality of data points where the first confidence value of the respective data points meets a threshold.

4. The method of claim 3 further comprising:
perturbing each of the plurality of data points where the first confidence value of the respective data points fails to reach the threshold, the perturbing resulting in one or more perturbed data points corresponding to each of the data points with first confidence values failing to reach the threshold;
inputting the perturbed data points to the trained AI model;
receiving, from the trained AI, a second confidence value corresponding to each of the perturbed data points;
retaining each of the perturbed data points in the subset of the plurality of data points where the second confidence value of the respective perturbed data points meets the threshold; and
retaining each of the data points corresponding to perturbed data points with second confidence values that meets the threshold.

5. The method of claim 2 wherein the trained AI model is a regression type of model and wherein the method further comprises:
inputting the plurality of data points to the trained AI model;
receiving, from the trained AI, a first predicted value corresponding to each of the plurality of data points resulting in a plurality of first predicted values;
calculating a set of first scores, each of the first scores corresponding one of the predicted values and based on the plurality of first predicted values; and
retaining each of the data points wherein their respective first score is within a threshold.

6. The method of claim 2 wherein the trained AI model is a regression type of model and wherein the method further comprises:
receiving, from the trained AI, a first predicted value corresponding to each of the plurality of data points resulting in a plurality of first predicted values;
calculating a set of first scores, each of the first scores corresponding one of the predicted values and based on the plurality of first predicted values;
perturbing each of the plurality of data points, the perturbing resulting in one or more perturbed data points corresponding to each of the plurality of data points;
inputting the plurality of perturbed data points to the trained AI model;
receiving, from the trained AI, a second predicted value corresponding to each of the perturbed data points resulting in a plurality of second predicted values;
calculating a set of second scores, each of the second scores corresponding to one of the predicted values and based on the plurality of second predicted values; and
retaining each of the data points and perturbed data points wherein at least one of their respective first scores and second scores is within a threshold.

7. The method of claim 6 further comprising:
calculating the set of first scores by finding a first difference between each of the first predicted values and a mean of the plurality of first predicted values and dividing each of the differences by a standard deviation of the plurality of first predicted values; and
calculating the set of second scores by finding a second difference between each of the second predicted values and a mean of the plurality of second predicted values and dividing each of the differences by a standard deviation of the plurality of second predicted values.

8. An information handling system comprising:
one or more processors;
a memory coupled to at least one of the processors;
a set of computer program instructions stored in the memory and executed by at least one of the processors in order to perform actions comprising:
inputting a plurality of data points to a trained artificial intelligence (AI) model with an outlier model that identifies data points on which the AI model has been trained;
receiving, from the outlier model, a value corresponding to each of the plurality of data points, wherein the received value indicates a prediction of whether the AI model has been trained with the respective data point; and
performing a bias analysis of the trained AI model using a subset of the plurality of data points that received a value indicating that the trained AI model has been trained with the respective data point.

9. The information handling system of claim 8 wherein the actions further comprise:
training the outlier model to predict whether the trained AI model has been trained with a given data point.

10. The information handling system of claim 9 wherein the trained AI model has been trained to recognize a plurality of classifications and wherein the actions further comprise:
inputting the plurality of data points to the trained AI model;
receiving, from the trained AI, a first confidence value corresponding to each of the plurality of data points; and
retaining each of the plurality of data points in the subset of the plurality of data points where the first confidence value of the respective data points meets a threshold.

11. The information handling system of claim 10 wherein the actions further comprise:
perturbing each of the plurality of data points where the first confidence value of the respective data points fails to reach the threshold, the perturbing resulting in one or more perturbed data points corresponding to each of the data points with first confidence values failing to reach the threshold;
inputting the perturbed data points to the trained AI model;
receiving, from the trained AI, a second confidence value corresponding to each of the perturbed data points;
retaining each of the perturbed data points in the subset of the plurality of data points where the second confidence value of the respective perturbed data points meets the threshold; and
retaining each of the data points corresponding to perturbed data points with second confidence values that meets the threshold.

12. The information handling system of claim 9 wherein the trained AI model is a regression type of model and wherein the actions further comprise:
inputting the plurality of data points to the trained AI model;
receiving, from the trained AI, a first predicted value corresponding to each of the plurality of data points resulting in a plurality of first predicted values;
calculating a set of first scores, each of the first scores corresponding one of the predicted values and based on the plurality of first predicted values; and
retaining each of the data points wherein their respective first score is within a threshold.

13. The information handling system of claim 9 wherein the trained AI model is a regression type of model and wherein the actions further comprise:
receiving, from the trained AI, a first predicted value corresponding to each of the plurality of data points resulting in a plurality of first predicted values;
calculating a set of first scores, each of the first scores corresponding one of the predicted values and based on the plurality of first predicted values;
perturbing each of the plurality of data points, the perturbing resulting in one or more perturbed data points corresponding to each of the plurality of data points;
inputting the plurality of perturbed data points to the trained AI model;
receiving, from the trained AI, a second predicted value corresponding to each of the perturbed data points resulting in a plurality of second predicted values;
calculating a set of second scores, each of the second scores corresponding to one of the predicted values and based on the plurality of second predicted values; and
retaining each of the data points and perturbed data points wherein at least one of their respective first scores and second scores is within a threshold.

14. The information handling system of claim 13 wherein the actions further comprise:
calculating the set of first scores by finding a first difference between each of the first predicted values and a mean of the plurality of first predicted values and dividing each of the differences by a standard deviation of the plurality of first predicted values; and
calculating the set of second scores by finding a second difference between each of the second predicted values and a mean of the plurality of second predicted values and dividing each of the differences by a standard deviation of the plurality of second predicted values.

15. A computer program product stored in a computer readable storage medium, comprising computer program code that, when executed by an information handling system, performs actions comprising:
inputting a plurality of data points to a trained artificial intelligence (AI) model with an outlier model that identifies data points on which the AI model has been trained;
receiving, from the outlier model, a value corresponding to each of the plurality of data points, wherein the received value indicates a prediction of whether the AI model has been trained with the respective data point; and
performing a bias analysis of the trained AI model using a subset of the plurality of data points that received a value indicating that the trained AI model has been trained with the respective data point.

16. The computer program product of claim 15 wherein the actions further comprise:
training the outlier model to predict whether the trained AI model has been trained with a given data point.

17. The computer program product of claim 16 wherein the trained AI model has been trained to recognize a plurality of classifications and wherein the actions further comprise:
inputting the plurality of data points to the trained AI model;
receiving, from the trained AI, a first confidence value corresponding to each of the plurality of data points; and
retaining each of the plurality of data points in the subset of the plurality of data points where the first confidence value of the respective data points meets a threshold.

18. The computer program product of claim 17 wherein the actions further comprise:
perturbing each of the plurality of data points where the first confidence value of the respective data points fails to reach the threshold, the perturbing resulting in one or more perturbed data points corresponding to each of the data points with first confidence values failing to reach the threshold;
inputting the perturbed data points to the trained AI model;
receiving, from the trained AI, a second confidence value corresponding to each of the perturbed data points;
retaining each of the perturbed data points in the subset of the plurality of data points where the second confidence value of the respective perturbed data points meets the threshold; and
retaining each of the data points corresponding to perturbed data points with second confidence values that meets the threshold.

19. The computer program product of claim 16 wherein the trained AI model is a regression type of model and wherein the actions further comprise:
inputting the plurality of data points to the trained AI model;
receiving, from the trained AI, a first predicted value corresponding to each of the plurality of data points resulting in a plurality of first predicted values;
calculating a set of first scores, each of the first scores corresponding one of the predicted values and based on the plurality of first predicted values; and
retaining each of the data points wherein their respective first score is within a threshold.

20. The computer program product of claim 16 wherein the trained AI model is a regression type of model and wherein the actions further comprise:
receiving, from the trained AI, a first predicted value corresponding to each of the plurality of data points resulting in a plurality of first predicted values;
calculating a set of first scores, each of the first scores corresponding one of the predicted values and based on the plurality of first predicted values;
perturbing each of the plurality of data points, the perturbing resulting in one or more perturbed data points corresponding to each of the plurality of data points;
inputting the plurality of perturbed data points to the trained AI model;
receiving, from the trained AI, a second predicted value corresponding to each of the perturbed data points resulting in a plurality of second predicted values;
calculating a set of second scores, each of the second scores corresponding to one of the predicted values and based on the plurality of second predicted values; and
retaining each of the data points and perturbed data points wherein at least one of their respective first scores and second scores is within a threshold.
